(19) United States
(12) Patent Application Publication
(10) Pub. No.: US 2024/0344663 A1
(43) Pub. Date: Oct. 17, 2024

(54) SUPPLY OF HIGH-PRESSURE CO2 TO A USER STATION BY ADDING A LIQUEFACTOR AT THE USAGE POINT

(71) Applicant: L'Air Liquide, Societe Anonyme pour l'Etude et l’Exploitation des Procedes Georges Claude, Paris (FR)

(72) Inventors: Bruno ALBAN, Bagneux (FR); Dominique BRAS, Bagneux (FR)

(73) Assignee: L'Air Liquide, Societe Anonyme pour l'Etude et l’Exploitation des Procedes Georges Claude, Paris (FR)

(21) Appl. No.: 18/633,409

(22) Filed: Apr. 11, 2024

(30) Foreign Application Priority Data
Apr. 14, 2023 (EP) EP 23167917.6

(51) Int. Cl. F17C 7/02

(52) U.S. Cl. CPC F17C 7/02; F17C 2221/013; F17C 2223/035; F17C 2227/0337

(57) ABSTRACT

An installation for supplying a user station with pure or substantially pure liquid CO₂ at high pressure, preferably in the range 50-60 bar, from a liquid CO₂ source, the installation comprising means for compressing the liquid CO₂ that are positioned between the source and the user station, wherein a liquefier for the fluid flowing between the source and the compression means is positioned at the inlet of the compression means.

### CROSS REFERENCE TO RELATED APPLICATIONS

This application claims the benefit of priority under 35 U.S.C. § 119 (a) and (b) to European patent application No. EP23167917.6, filed Apr. 14, 2023, the entire contents of which are incorporated herein by reference.

### FIELD OF THE INVENTION

The present invention relates to the field of installations for supplying liquid CO₂ to a user station.

### BACKGROUND OF THE INVENTION

Considering the example of machining of metal parts under a liquid nitrogen spray, the higher the spraying pressure in the machining zone, the better the coefficients of heat exchange.

However, when the cryogen, for example liquid nitrogen, is sprayed, the expansion thereof creates a gas at the spray nozzle. The quantity of gas generated is directly proportional to the temperature and pressure of the liquid nitrogen upstream of the nozzle. The advantage of having a subcooled liquid will therefore be understood.

The following is therefore intended to supply a user station with pure or substantially pure liquid CO₂ that is below but near to the critical point, typically approximately 50-60 bar, and at or close to ambient temperature. Such an application may be referred to as a “high-pressure CO₂” application.

It is known that numerous industrial applications require “high-pressure” CO₂. Such applications notably include all supercritical CO₂ applications, i.e. beyond the critical point of CO₂ (approximately 32° C. and 74 bar).

The usage pressure is very high, notably to enable cleaning actions or fragrance extraction actions or complex chemistry by modulating the properties of the fluids according to the operating conditions (i.e. essentially pressure and temperature).

CO₂ is most frequently stored under temperature conditions lower than the conditions required by the application at the end user station, i.e. usually:
15-20 bar abs (and therefore approximately −30 to −20° C.) in a cooled storage facility. There is a CO₂ liquid-gas equilibrium inside the storage facility that is predicted by an equilibrium curve that can for example be seen in a thermodynamic Mollier diagram for CO₂. To keep the whole cool, the packaging or the storage facility is then insulated to limit the ingress of heat (from the environment surrounding the storage facility), such ingress increasing the pressure of the storage facility by evaporation, or
45-55 bar abs (and at ambient temperature) for an ambient-temperature storage facility. There is also a CO₂ liquid-vapour equilibrium in this case, but at a higher pressure given that the storage facility or packaging is not insulated or kept cold.

Thus, the following means are most frequently used to go from the liquid CO₂ storage facility to the usage point:
A first step of increasing the pressure of the cryogenic liquid to a pressure below the critical point of CO₂ but in any case relatively close to this point (50 to 60 bar, for example). This can be referred to as high-pressure liquid CO₂.
Then a second step of reaching the target pressure required at the usage point, for example in the case of a supercritical application. This second step involves exceeding the conditions of the critical point and entering the supercritical domain.

This pressurization of the liquid CO₂ is often carried out using volumetric pumps, referred to as cryogenic pumps. These pumps, which are based on pistons, admit little or no gas. This problem can be assimilated to cavitation for centrifugal pumps.

The pumps therefore have to be supplied with liquid only, i.e. what is referred to as a pure liquid.

However, during a stoppage of variable duration (potentially transitory) of the final application, a part of the liquid trapped in the pipes may evaporate a little. This is caused by the ingress of heat to a varying degree as a function of the conditions around the user installation (between the liquid source and its usage point, in the connection pipes of the different equipment used for implementation).

It may be noted that during continuous usage (i.e. continuous use of high-pressure liquid CO₂), the cryogenic liquid draws enough cold from the storage facility to compensate the ingress of heat and prevent the aforementioned unwanted evaporation.

However, if no provision is made to discharge the gas resulting from evaporation of the liquid CO₂, this gas will inevitably move towards the user application when usage recommences and will be pumped by the pump, disturbing operation of the pumps or damaging these pumps.

It can be argued that the evaporation of a part of the liquid increases the pressure, which would tend to encourage liquefaction of the gas phase (i.e. the opposite effect to the effect mentioned above). Nonetheless, if there is significant evaporation and no means for discharging it (see below), the gas will be discharged with the next usage and will inconvenience the user.

For example, a device may be used to manage this quantity of unwanted gas by allowing it to return upstream, i.e. back to the storage facility or the packaging, but this is not feasible in many cases: no return to sources to prevent contamination (use of non-return valves, for example).

In short, where the ingress of heat into the installation, and in particular into the pipes that are not usually insulated (which in any case only has a retarding effect on this phenomenon) is inevitable in the event of stoppage, the evaporation of some of the cryogenic liquid therefore cannot be prevented or avoided.

It is for this reason that an expansion and venting valve is always installed on a line having a portion in which the cryogenic liquid, which is always quick to evaporate, may be trapped. This is immediate because the liquid is always at equilibrium with its gas phase under the storage conditions, unless a subcooler for the liquid is installed at the outlet of the liquid CO₂ source (in which case cooling beyond the equilibrium inside the source is provided to prevent evaporation following the ingress of heat).

In other words, only a small amount of heat is needed to evaporate a small amount of liquid at equilibrium, and therefore a small amount of cooling power is needed to re-liquefy said liquid.

It can also be seen, again from the thermodynamic Mollier diagram for CO₂, that this phenomenon is greater closer to the critical point. This is the case for a high-pressure CO₂ application, since the pressure is typically between 50 and 60 bar, which then enables the end user to reach the usage conditions, notably beyond the critical point of CO₂, in a single compression stage.

This is because the same quantity of heat produces more gas as the pressure of the liquid at equilibrium increases (“lever” rule, a simple expression of a mass balance, to calculate the relative quantity of gas and of liquid following heating or cooling in the gas-liquid phase).

The following means may be used to limit or prevent this unwanted vaporization:
Subcooling, for example by passing over an exchanger, the liquid coming out of the storage facility at equilibrium. However, this entails a certain cost (operating and investment), is wasteful in continuous operation (which characterizes most uses of liquid CO₂ in general), and in any case ultimately allows some evaporation if heating is prolonged over time, or
Discharging the gas through a valve, or a two-phase separator, positioned between the location where the gas is produced and the end user station. This also entails a certain cost and the venting of the CO₂ produces a large quantity of cold and snow. This is because, below 5.3 bar, the liquid released at the same time as the gas generates a three-phase mixture (gas, liquid and solid (“dry” snow)) that is difficult to control.

Discharging may be blocked in the event of accumulation of snow and ice with the ambient moisture at the discharge point. It can also be noted that the discharge of a part of the fluid (and therefore the gas-liquid mixture) inevitably disturbs the main liquid flow (there is one inlet via the line and two outlets). In summary, a degassing pot could for example be positioned after all of the points of heat ingress, i.e. as close as possible to the usage point.

### SUMMARY OF THE INVENTION

In certain embodiments, the present invention specifically relates to supplying a liquid referred to as “pure” or substantially pure, a notion well known to the person skilled in the art, which is highly sought-after in numerous industries for well-known reasons relating to improved “cryogenic quality” in terms of available cooling power.

Such a “pure” or subcooled liquid is liquid at low pressure and at a lower temperature than when it was at a higher pressure.

One of the objectives of the present invention is therefore to propose a technical solution to the problems set out above, moving away from and improving on the solutions proposed in the literature to date.

As set out in greater detail below, the present invention proposes implementing a liquefier as close as possible to the usage point.

The following example is intended to enhance comprehension of the present invention and relates to a user station supplied from a cylinder of liquid CO₂ with a dip tube, in which the pipes between the bottle and its compressor may be subject to the ingress of heat resulting in evaporation of the liquid CO₂. The gas cannot be discharged and returned to the cylinder because the line is fitted with a non-return valve. Furthermore, if it is a gas/liquid mixture that reaches the compressor (most commonly a piston compressor), said compressor will malfunction and possibly break (the compressor only admits pure liquid).

One of the embodiments of the invention therefore proposes adding a liquefier to the inlet of the compressor to minimize the connection length between the liquefier and the compressor, thereby minimizing the formation of gas between the liquefier and the compressor.

Thus:
Regardless of whether it is produced upstream (i.e. between the liquid CO₂ storage facility and the point of delivery of the high-pressure CO₂, typically at 50-60 bar of liquid CO₂), the gas generated inside the liquid will be liquefied before being used.

This prevents the formed gas from moving downstream through the installation, i.e. towards the high-pressure CO₂ user station.
The cooling power required to liquefy the formed gas is very limited and very reasonable. In other words, proximity to the critical point means that the effort required is limited. Consequently, this liquefaction can be carried out using a simple cheap installation that draws little electricity. In most cases, a final temperature of between 5° C. and 15° C. is broadly sufficient.

According to one of the embodiments of the invention, an implementing installation including the following elements is used:
A refrigeration unit for producing cold water at a temperature advantageously within the range of 5° C. to 15° C., via a coil.
A tank containing the water and two coils:
   A first coil in which the refrigerant liquid flows from the refrigeration unit to cool the water in which this coil is immersed, said water being used as an intermediary, or medium, to convey cooling power to the fluid CO₂ to be cooled (indirect heat exchange).
   A second coil for conveying the high-pressure fluid CO₂, a two-phase gas-liquid mixture, the gas having been generated by an ingress of heat. As it moves along the coil, the cooling power is transferred from the surrounding cold water to the gas-liquid mixture, enabling the gas to be liquefied.
   The design and selection of the operating conditions ensures the efficient transfer of the cooling power generated by the refrigeration unit (transfer efficiency), liquefaction of the gas, or even subcooling of the high-pressure liquid CO₂. This also helps to improve compression of this liquid (or more specifically the pressure increase thereof).

Other means may be used to implement this liquefier, provided that sufficient cooling power is transferred from a cold source (glycolated water from a network could be used instead of a refrigeration unit) to the “hot” fluid (i.e. the high-pressure CO₂ that is a two-phase gas-liquid mixture).

Therefore, if the user site already has cold water, for example via a network of iced water, the small-tank liquefier mentioned above could be replaced by a simple exchanger. The cold fluid will be iced water from the network and the hot fluid (heat source) will be the CO₂ to be cooled/liquefied.

### BRIEF DESCRIPTION OF THE DRAWINGS

Further features and advantages of the invention will become apparent from the description hereinafter of embodiments, which are given by way of illustration but without any limitation, the description being given in relation with the following attached figures:

FIG. 1 shows a partial schematic view of an installation suitable for implementing the present invention.

### DETAILED DESCRIPTION OF THE INVENTION

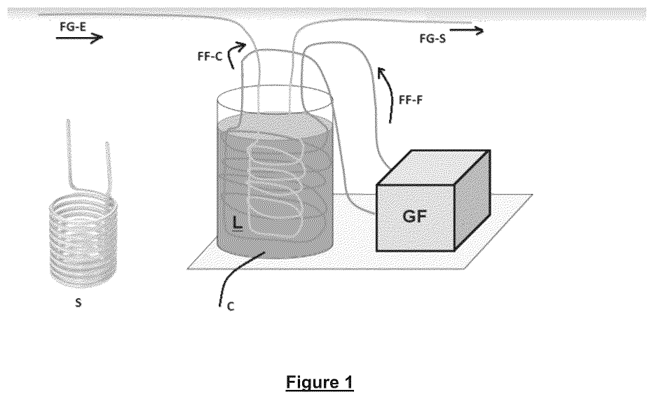

FIG. 1 attached is a partial schematic view of an installation suitable for implementing the present invention, including the following installation elements:
i) C: a “buffer” tank containing a liquid L (water or glycolated water, for example)

The tank is provided with two coils to enable heat exchanges:
Between the CO₂ and the liquid medium,
Between the refrigerant fluid (coming from the refrigeration unit GF) and the liquid medium.

(Reference sign S provides an example of coils that may be used in the tank C)
j) GF: a refrigeration unit
k) FG-E: CO₂ to be cooled, to be liquefied (therefore hot) flowing from the CO₂ source towards the tank C.

The CO₂ is high-pressure CO₂, usually at 50-60 bar and ambient temperature.

The CO₂ is therefore liquid CO₂ having a small quantity of unwanted gas caused by the ingress of heat occurring upstream.
l) FG-S: Cooled CO₂ flowing from the tank C towards the user station, a pure liquid (the unwanted gas has been liquefied).
m) FF-F: The cold refrigerant fluid flowing from the refrigeration unit towards the tank.
n) FF-C: The heated refrigerant fluid flowing from the tank towards the refrigeration unit.

The invention therefore relates to an installation for supplying a user station with pure or substantially pure liquid CO₂ at high pressure, preferably in the range 50-60 bar, from a liquid CO₂ source, the installation comprising means for compressing the liquid CO₂ that are positioned between the source and the user station, characterized in that a liquefier for the fluid flowing between the source and the compression means is positioned at the inlet of the compression means

An example application and implementation calculations of the invention are described below.

The example relates to a required high-pressure CO₂ flow of D=60 kg/h. A supply between 55 and 60 bar is therefore required.

In this example, the CO₂ is at a temperature of between 15° C. and 20° C., which corresponds to a point on the CO₂ gas-liquid (or liquid-vapour) equilibrium (Mollier diagram).

The CO₂ retains a thermal capacity or specific heat capacity of 5 J/kg/K under these conditions.

Therefore, the total heat exchanged to move from 20° C. to 12° C. is:

$$Q = 666.7 W = D * Cp * ( 20 - 10 )$$

The objective is to subcool this flow to 12° C. using a coil that is immersed in cold water kept at 10° C.

This means that this coil is a heat exchanger in which:
The cold liquid: the water in the bath set and held at a temperature of 10° C.
The “hot” liquid: two-phase liquid-gas CO₂ entering at approximately 20° C. and leaving at approximately 12° C.

A countercurrent exchange model is used and the logarithmic temperature difference ΔT=4.97° C. represents the difference between the temperatures between the two exchanging fluids at the two ends of the coil.

Care is taken to ensure that the output temperature of the CO₂ flow is slightly above the temperature of the cold fluid (12° C.>10° C.). This prevents heat exchange “pinch” and therefore stoppage of the transfer in this selected countercurrent model.

An overall heat transfer coefficient of U-4843 W/m²/K can then be deduced by applying the McAdams formula. This known formula can be applied to a tube with turbulence having a constant external wall temperature (in this case cold fluid).

If a line having an internal diameter of 4 mm is chosen (to ensure turbulence and therefore good heat transfer), a minimum required length can be calculated as Lmin=2.2 m. The general classic heat exchange formula is then applied to the coil with:

Q=U*A*ΔT
where A is the total exchange area of the tube, i.e. the total average surface area (between external and internal diameter) of the tube of length L.

The following is implemented for this application, which involves keeping a 55-60 bar high-pressure CO₂ flow at a maximum of 12° C., where said flow would otherwise reach 20° C. as a result of the gas caused by the ingress of heat from the installation:
A 20-litre tank that contains a refrigeration unit and a copper coil to keep the water in the bath at a target temperature of between 5° C. and 15° C.
A stainless-steel coil with an internal diameter of approximately 4 mm and a length of 10 m, bearing in mind that the minimum length required for efficient transfer has been calculated at 2.2 m.

The following can be noted:
1. A bath temperature of 5° C. would enable the minimum exchange length to be further reduced to approximately 1.5 m. This enables the flexible use of the liquefier thus dimensioned to liquefy any gas that has formed before the usage point.
2. The equipment can be easily adapted to other flow conditions and target temperatures at the usage point.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed.

Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. An installation for supplying a user station with pure or substantially pure liquid CO₂ at high pressure in the range of 50-60 bar, the installation comprising:
a. means for compressing the liquid CO₂ that are positioned between the source and the user station,
b. a liquefier for the fluid of CO₂ flowing between a source and the compression means is positioned at an inlet of the compression means.

2. The installation according to claim 1, wherein the liquefier implements a heat exchange between a cold fluid and the fluid of CO₂, the cold fluid comprising:
glycolated water, or
cold water coming from a network of iced water.

3. The installation according to claim 1, wherein the liquefier is implemented using the following means:
a refrigeration unit configured to produce cold water at a temperature within a range of 5° C. to 15° C., via a coil,
a tank containing water or another medium, and two coils:
a first coil in which a refrigerant liquid flows from the refrigeration unit to cool the water or the medium in which this coil is immersed, said water thus being usable as an intermediary to convey cooling power to the fluid CO₂ to be cooled or liquefied coming from said CO₂ source,
a second coil able to receive a flow of two-phase gas-liquid high-pressure fluid CO₂, the cold power transferred by the surrounding cold water or the surrounding cold medium being transferred to the fluid CO₂ flowing in this second coil and enabling this fluid to be cooled and to liquefy the gas phase thereof, before conveying this fluid thus cooled towards said user station.
